(19) United States
(12) Patent Application Publication
(10) Pub. No.: US 2024/0394987 A1
(43) Pub. Date: Nov. 28, 2024

(54) SELFIE VOLUMETRIC VIDEO

(71) Applicant: Dolby Laboratories Licensing Corporation, San Francisco, CA (US)

(72) Inventor: Ajit NINAN, San Jose, CA (US)

(73) Assignee: Dolby Laboratories Licensing Corporation, San Francisco, CA (US)

(21) Appl. No.: 18/694,399

(22) PCT Filed: Sep. 23, 2022
(86) PCT No.: PCT/US2022/076978

§ 371 Date: Mar. 21, 2024

Related U.S. Application Data
(60) Provisional application No. 63/247,999, filed on Sep. 24, 2021.

(30) Foreign Application Priority Data
Sep. 24, 2021 (EP) 21198906.6

(51) Int. Cl. G06T 19/00; G06K 7/14; G06T 7/20; G06T 15/20; G06T 15/50

(52) U.S. Cl. CPC G06T 19/006; G06K 7/1417; G06T 7/20; G06T 15/20; G06T 15/50; G06T 2207/20081; G06T 2207/30244; G06T 2219/024

(57) ABSTRACT

Camera tracking data with respect to a camera operating in a 3D physical space is received. An image portion depicting one or more visual objects not physically present in the 3D physical space is generated using a camera perspective derived from the camera tracking data. The one or more visual objects is caused to be visually combined with the camera perspective into a personal image taken by the camera.

### CROSS-REFERENCE TO RELATED APPLICATIONS

This application claims the benefit of priority from U.S. Provisional Patent Application No. 63/247,999, filed on 24 Sep. 2021, and EP Patent Application No. 21198906.6, filed on 24 Sep. 2021, each one incorporated by reference in their entirety.

### BACKGROUND

The present invention relates generally to video images, and in particular, to selfie volumetric video.

There are many ways to convey special moments, whether for personal enjoyment, sharing with friends and families, or product/service promotions. As social networking applications become more and more popular, images or videos can be used, for example as Instagram moments, to share one's activities, convey special moments in life or community, or attract people to interesting places or events.

In some cases, visitors may wish to take selfie pictures or stream videos with famous characters at some special places such as in the presence of the Eiffel tower or the Louvre Museum. Cardboard cutouts representing famous characters may be used in these places for picture or video taking purposes.

However, these characters represented in the cutouts are not there in real life and hence cannot interact with people. It is relatively easy even in still pictures to detect that these characters are not real life people. This problem gets worsened when videos instead of still pictures are taken with the characters represented in the cardboard cutouts.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1A and FIG. 1B illustrate example interactions between real people and depicted visual objects or characters on an image rendering screen;

FIG. 2A and FIG. 2B illustrate example systems for enhancing personal images or videos;

FIG. 3A and FIG. 3B illustrate example user devices;

FIG. 4 illustrates an example process flow; and

FIG. 5 illustrates an example hardware platform on which a computer or a computing device as described herein may be implemented.

### DESCRIPTION OF EXAMPLE EMBODIMENTS

Example embodiments, which relate to selfie volumetric video, are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:
1. GENERAL OVERVIEW
2. PERSPECTIVE CORRECT VISUAL OBJECT PLACEMENT
3. CAMARA TRACKING DATA COLLECTION
4. CHARACTER OR VISUAL OBJECT INSERTION
5. EXAMPLE USER DEVICE
6. EXAMPLE PROCESS FLOWS
7. IMPLEMENTATION MECHANISMS—HARDWARE OVERVIEW
8. EQUIVALENTS, EXTENSIONS, ALTERNATIVES AND MISCELLANEOUS

### 1. GENERAL OVERVIEW

This overview presents a basic description of some aspects of an example embodiment of the present invention. It should be noted that this overview is not an extensive or exhaustive summary of aspects of the example embodiment. Moreover, it should be noted that this overview is not intended to be understood as identifying any particularly significant aspects or elements of the example embodiment, nor as delineating any scope of the example embodiment in particular, nor the invention in general. This overview merely presents some concepts that relate to the example embodiment in a condensed and simplified format, and should be understood as merely a conceptual prelude to a more detailed description of example embodiments that follows below. Note that, although separate embodiments are discussed herein, any combination of embodiments and/or partial embodiments discussed herein may be combined to form further embodiments.

Example embodiments described herein relate to image generation. Camera tracking data with respect to a camera operating in a 3D physical space is received. An image portion depicting one or more visual objects not physically present in the 3D physical space is generated using a camera perspective derived from the camera tracking data. The one or more visual objects is caused to be visually combined with the camera perspective into a personal image taken by the camera.

In some example embodiments, mechanisms as described herein form a part of a media processing system, including but not limited to any of: AR device, VR device, MR device, cloud-based server, mobile device, virtual reality system, augmented reality system, head up display device, helmet mounted display device, CAVE-type system, wall-sized display, video game device, display device, media player, media server, media production system, camera systems, home-based systems, communication devices, video processing system, video codec system, studio system, streaming server, cloud-based content service system, a handheld device, game machine, television, cinema display, laptop computer, netbook computer, tablet computer, cellular radiotelephone, electronic book reader, point of sale terminal, desktop computer, computer workstation, computer server, computer kiosk, or various other kinds of terminals and media processing units.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2. PERSPECTIVE CORRECT VISUAL OBJECT PLACEMENT

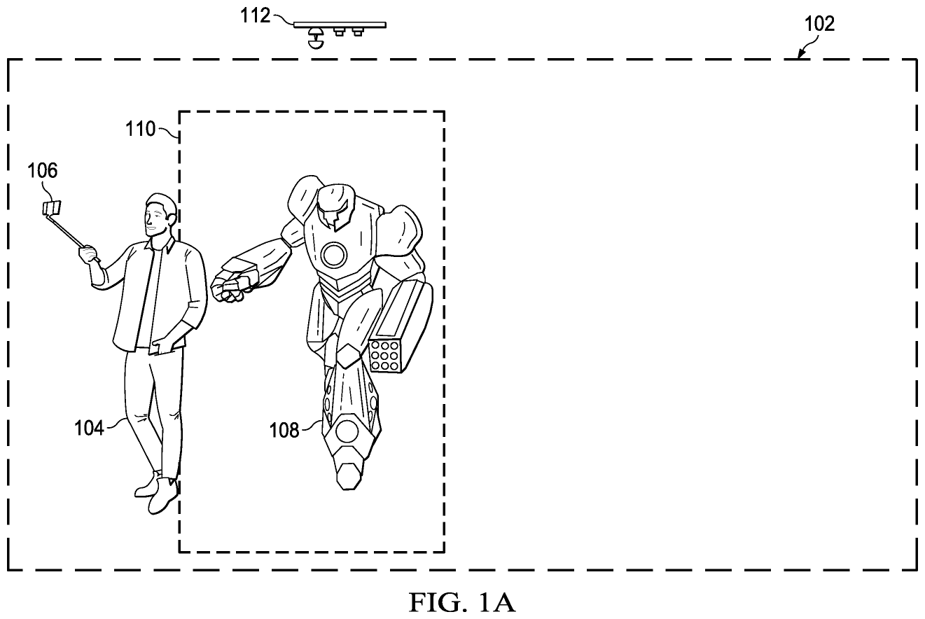

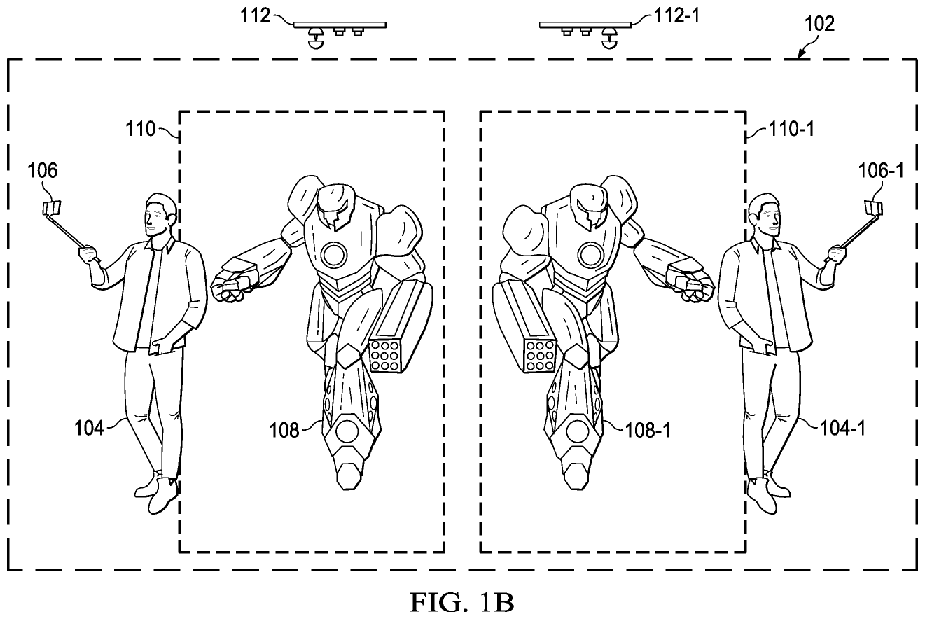

FIG. 1A illustrates example interaction between real people and depicted visual objects or characters on an image rendering screen such as a light emitting diode (LED) display screen 102 at a venue including but not limited to a movie theater.

As shown, a person (or a user) 104 may hold or operate a user device with a camera 106 to take personal (e.g., selfie, etc.) images or videos in which the person (104) interacts with a character 108 depicted in a screen portion 110 of the LED display screen (102) behind the person (104).

Under other approaches that do not implement techniques as described herein, characters and scenes depicted on such an image screen would look rather flat and would not have interaction perceivable with real people in front of the image screen. The depicted characters on the image screen and the real people in front of the image screen would be perceived in separate physical worlds or spaces.

In sharp contrast, under techniques as described herein, screen images rendered in the image screen (102) are adjusted in accordance with positions and orientations of the camera (106). A camera tracker 112 may be used to track time varying movements of the camera (106). Camera tracking information generated in real time or in near real time by the camera tracker (112) can be used to determine, estimate or predict the position and orientation of the camera (106) at each time point in a plurality of consecutive time points covering a time duration or interval. The position and orientation of the camera (106) can be further used by an image rendering system to (e.g., contemporaneously, etc.) adjust or project screen images or visual characters or objects depicted therein in terms of their positions, orientations, sizes, movements, gestures, etc., in relation to the camera (106). The adjusted screen images generated based at least in part on the camera tracking information can be rendered or displayed on the image screen (102).

While the camera (106) moves to different positions and orientations of the camera (106), visual characters or objects depicted in the screen images moves along with the movements of the camera (106) to cause the personal images or videos taken by the person (104) to depict the visual characters or objects (e.g., 108 of FIG. 1A, etc.) rendered in the screen images to appear as if these visual characters or objects (e.g., 108 of FIG. 1A, etc.) are present in the same physical space as the person (104).

For example, as the camera (106) turns, the person (104) will be depicted with a corresponding turning in the personal images or videos, and so are the visual characters or object (e.g., 108 of FIG. 1A, etc.) rendered in the screen images. As a result, the visual characters or object (e.g., 108 of FIG. 1A, etc.) rendered in the screen images have the same or a similar corresponding turning as the person (104), as captured in the personal images or videos. This provides a visual perception to a viewer of the personal images or videos that the person (104) is physically present with the visual characters or object (e.g., 108 of FIG. 1A, etc.) in the same physical world or space, rather than in separate physical worlds or spaces.

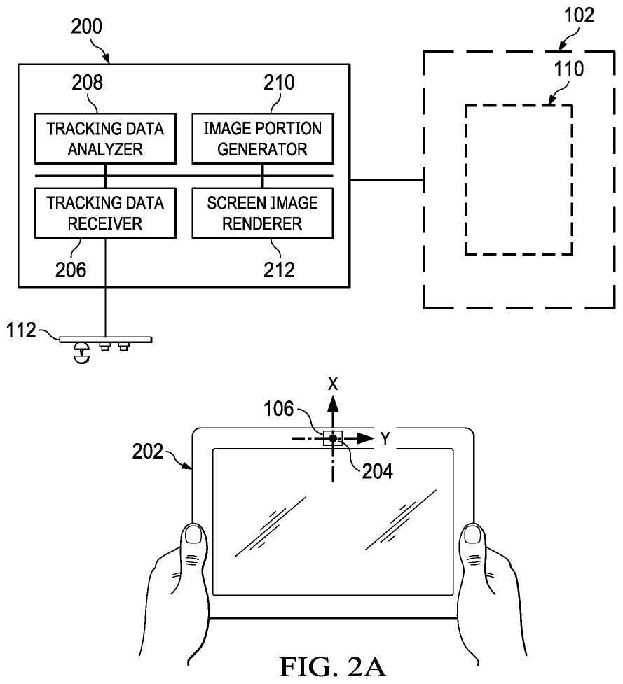

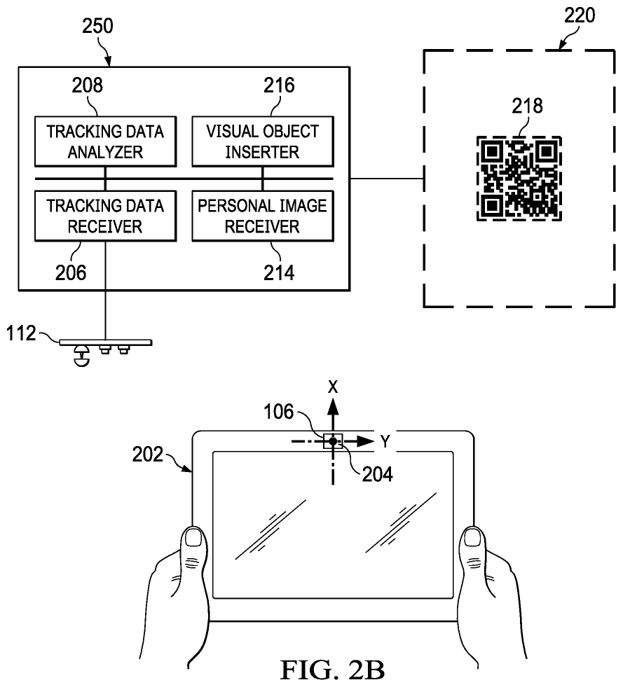

FIG. 2A illustrates an example screen image adjustment system 200 in which the position and/or orientation of a user device 202 may be tracked or monitored in real time while adjusted screen image portions are being rendered in the screen portion (110 of the image screen (102). Some or all of the components and/or devices as depicted in FIG. 2A may be implemented by one or more mechanical components, one or more electrooptical components, one or more computing devices, modules, units, etc., in software, hardware, a combination of software and hardware, etc.

As shown, the screen image adjustment system (200) comprises a tracking data receiver 206, a tracking data analyzer 208, an image portion generator 210, a screen image renderer 212, etc. The camera tracker (112) comprises one or more external sensors (e.g., camera sensors, non-camera sensors, webcams, etc.).

Some or all of the components and/or devices as depicted in FIG. 2A may be communicatively (e.g., wirelessly, with wired connections, etc.) coupled with some other components/devices as depicted in FIG. 2A or with other components/devices not depicted in FIG. 2A. For example, the screen image adjustment system (200) may communicate with some or all of the camera tracker (112), the user device (200), etc., over one or more wireless or wired data communication links.

The camera tracker (112) is deployed—to generate real time or near real time camera tracking data—in the 3D physical space in which the person (104) operates the user device (202) the includes the camera (106) while the screen portion (110) of the screen image display (102) is rendering adjusted screen image portions in the screen images rendered on the screen image display (102). Example 3D physical spaces may include, but are not necessarily limited to only, any of: a personal space, a shared space, a cinema, a theater, a concert hall, an auditorium, an amusement park, a bar, an exhibition hall, a venue, a production studio, etc.

The screen image adjustment system (200), or the tracking data receiver (206) therein, collects or receives the camera tracking data generated by the camera tracker (112). In some operational scenarios, a single camera tracker (e.g., 112, etc.) may be deployed in the 3D physical space to track or monitor some or all cameras present in the 3D physical space. In some operational scenarios, multiple camera trackers (e.g., one of which is 112, etc.) may be deployed in the 3D physical space to track or monitor respective cameras in some or all cameras present in the 3D physical space.

The screen image adjustment system (200), or the tracking data analyzer (208) therein, uses or performs analysis on the camera tracking data to determine, estimate or predict the real time or near real time position and orientation of the camera (106) in the 3D physical space. By way of illustration but not limitation, the position and orientation of the camera (106) may be represented with a device stationary coordinate system that is stationary to the camera (106) or the user device (202). For example, the position (e.g., 204, etc.) may be represented with a position—in reference to a stationary coordinate system (not shown) that is stationary to the 3D physical space—of the coordinate origin of the device stationary coordinate system such as a Cartesian coordinate system. The orientation of the camera (106) may be represented with orientations or directions—in reference to a stationary coordinate system (not shown) that is stationary to the 3D physical space—of axes or coordinates of the device stationary coordinate system such as x, y, z (not shown; point into the 2D plane of FIG. 2A, etc.).

Additionally, optionally or alternatively, the tracking data analyzer (208) uses or performs analysis on the camera tracking data to determine, estimate or predict camera specific data relating to the camera (106). Example camera specific data may include, but are not necessarily limited to only, some or all of: device specific information (e.g., a specific type, model, manufactured, etc.) of the user device (202) that includes the camera (106); camera specific static information (e.g., a specific type, model, manufactured, etc.) of the camera (106); camera specific dynamic information (e.g., real time, near real time, dynamic camera settings, optical or digital zoom settings, etc.) of the camera (106); and so forth.

The screen image adjustment system (200), or the image portion generator (210) therein, uses the real time or near real time position and orientation of the camera (106) in the 3D physical space determined, estimated or predicted for a given time point to generate a perspective correct screen image portion depicting one or more (e.g., interactive, non-interactive, etc.) visual objects. Example visual objects as described herein may include, but are not necessarily limited to only, one or more of: human or non-human characters, scenarios, museums, artworks, etc.

The perspective correct screen image portion generated by the image portion generator (210) may be included as a part of an overall screen image. The overall screen image can be rendered by the screen image adjustment system (200), or the screen image renderer (212) therein in the screen image display (102) for or at the given time point, along with the perspective correct screen image portion rendered in the screen portion (110).

The screen image adjustment system (200), or the image portion generator (210) therein, may be configured, preconfigured or pre-stored with geometric information of the 3D physical space. Additionally, optionally or alternatively, the screen image adjustment system (200), or the image portion generator (210) therein, may access a (e.g., cloud based, non-cloud-based, etc.) data store to retrieve the geometric information of the 3D physical space. Example geometric information may include, but are not necessarily limited to only, some or all of: spatial 2D or 3D shapes and/or spatial dimensions and/or spatial orientations and/or world coordinates relating to the 3D physical space, or objects physically present/deployed/installed in the 3D physical space such as screen image display(s), walls, floors, ceiling, windows, doors, walkways, fixtures, furniture, fabrics, sculptures, frames, blinds, lights, audio speakers, electronics, physical obstacles, etc.

In some operational scenarios, the spatial shape and dimensions of the screen portion (110) may be (e.g., statically, etc.) set to be the same as those of all of the screen image display (102).

In some operational scenarios, the spatial location, shape and dimensions of the screen portion (110) may be (e.g., dynamically, etc.) set or determined by the image portion generator (210). The dynamically set or determined screen portion (110) may be (e.g., much, 50% or less, etc.) smaller than the screen image display (102). For example, using a combination of (i) the real time or near real time position and orientation of the camera (106) in the 3D physical space, (ii) the geometric information of the 3D physical space and (iii) some or all of the camera specific data, the image portion generator (210) can determine some or all of a location, shape, dimensions, etc., of the screen portion (110) such that the screen portion (110) is the same as or (e.g., slightly, with a relatively small safety margin, etc.) larger than an actual screen portion of the screen image display (102) as captured in the personal image or video of the camera (106) at the given time point.

In a first example, each of some or all of the visual objects can be represented with a respective 3D model (e.g., a 3D model with texture and depth information, etc.) among one or more 3D models constructed for the visual objects. The image portion generator (210) may implement or perform one or more 3D rendering (or 3D computer graphics) operations with CPUs, DSPs, GPUs, ASIC, FPGA, ICs, etc., to convert or project the 3D models into the perspective correct screen image portion to be rendered in the screen portion (110). The image portion generator (210) can logically place the 3D models at respective spatial positions and orientations near the person (104) in the 3D physical space. In addition, the image portion generator (210) can logically place a virtual camera at the spatial position and orientation of the (physical) camera (106) using same or similar camera settings as those of the camera (106) as indicated in the camera tracking data to render the 3D models into a 2D image portion representing the perspective correct screen image portion to be rendered in the screen portion (110).

Example 3D rendering operations may include, but are not necessarily limited to only, some or all of: 3D projection operations, image warping operations, image blending operations, SDR image rendering operations, HRD image rendering operations, photorealistic rendering operations, scanline rendering, ray tracing, real-time rendering operations, interactive content rendering operation, animated rendering operations, visual effects rendering operations, light reflection/scattering rendering operations, shading rendering operations, occlusion and/or disocclusion rendering operations, and so on. Some or all of these rendering operations may be used to simulate lens flares, depth of field, motion blur, optical characteristics (e.g., digital or optical camera magnification, zoom factor, depth of field, lens flares, motion blur, wide angle mode, fisheye mode, narrow angle mode, etc.) of the camera (106).

In second example, some or all of the visual objects can be visually represented in a (e.g., available, pre-shot, etc.) multi-view image or a stereoscopic image. The multi-view image or stereoscopic image may include a plurality of single-view images collectively covering a plurality of different reference viewing perspectives. Each single-view image in the plurality of single-view images in the multi-view image or stereoscopic image may correspond to or cover a respective viewing perspective in the plurality of reference viewing perspectives. Each reference viewing perspective here may be represented with a reference viewing position and a reference viewing direction corresponding to a viewing perspective of a reference viewer at the reference viewing position along the reference viewing orientation.

The image portion generator (210) may use the spatial position and orientation of the (physical) camera (106) to select one or more single-view images—from among the plurality of single-view images in the multi-view image or stereoscopic image—with one or more reference viewing perspectives relatively close to or coincide with the spatial position and orientation of the (physical) camera (106).

The image portion generator (210) may use a combination of (i) the real time or near real time position and orientation of the camera (106) in the 3D physical space, (ii) the geometric information of the 3D physical space and (iii) some or all of the camera specific data including but not limited to the camera settings of the camera (106) as indicated in the camera tracking data to scale, translate or rotate the one or more selected single-view images into one or more transformed single-view images and compose the transformed single-view images into the perspective correct image portion by performing one or more of warping, blending or interpolation operations performed with respect to the transformed single-view images. Example image composition using single-view images and/or multi-view images can be found in U.S. Patent Application No. 2018/0359489, by Haricharan Lakshman and Ajit Ninan, the entire contents of which are hereby incorporated by reference as if fully set forth herein.

The perspective correct image portion (e.g., in the first example, in the second example, etc.) corresponds to or covers a (e.g., real time, actual, etc.) viewing perspective of the camera (106) as represented by the (e.g., real time, actual, etc.) spatial position and orientation of the camera (106) such that the visual objects depicted in the perspective correct image portion have realistic or correct dimensions in relation to the dimensions of the person (104) and form realistic or correct spatial or geometric relationships with the person (104), as captured in the personal image or video by the camera (106).

### 3. CAMARA TRACKING DATA COLLECTION

It should be noted that, in many if not all operational scenarios, a camera tracker (e.g., 112 of FIG. 1A or FIG. 2A, etc.) as described herein may be used to not only track and generate camera tracking data in connection with cameras present in a 3D physical space but also take pictures or tracking images of persons, devices or other physical objects present in the 3D physical space. Indeed, the tracking images may be used by a tracking data analyzer (e.g., 208 of FIG. 2A, etc.) as described herein to generate at least a part of the camera tracking data.

For example, initially in the absence of device information about the specific type of the user device (202) or accurate camera tracking data, the screen image adjustment system (200) may not have specific information about which camera (e.g., one of front and/or back cameras, etc.) of the user device (202) is being used to generate personal images or videos. The system (200) also may not have accurate positional information of the camera (e.g., 106, etc.) being used on the user device (202). Even when the system (200) can determine the real time orientation of the user device (202), it may not be clear which camera is being used for generating the personal images or video and where the camera is exactly on the user device (202).

In some operational scenarios in which some or all of device information about the specific type of the user device (202) or accurate camera tracking data is not available, the screen image adjustment system (200) assumes default camera tracking data for the camera being used to generate the personal images or video in the 3D physical space. For example, a general camera setting (e.g., no zoom, no fisheye, etc.) may be assumed as default.

In some operational scenarios, the tracking images generated by the camera tracker (112) may contain partial or complete device image portions with unique or distinct device-specific shapes, textures, colors, textual information, model numbers or letterings on the user device (202).

The system (200)—or the tracking data analyzer (208) therein—can generate or determine some or all of the device information about the specific type of the user device (202) or related camera tracking data based at least in part on unique or distinct device-specific shapes, textures, colors, textual information, model numbers or letterings on the user device (202). For example, the tracking images can be used as input (e.g., to extract features or feature vectors for prediction, etc.) to a ML- or AI-based predictive model to select, predict or estimate the device information about the specific type of the user device (202) or related camera tracking data specifically for the user device (202). The predictive model may be (e.g., previously, continuously, etc.) trained to minimize prediction errors using a training dataset comprising training tracking images with ground truths such as labels indicating accurate device information (e.g., maker, brand, model, etc.) and related camera tracking data.

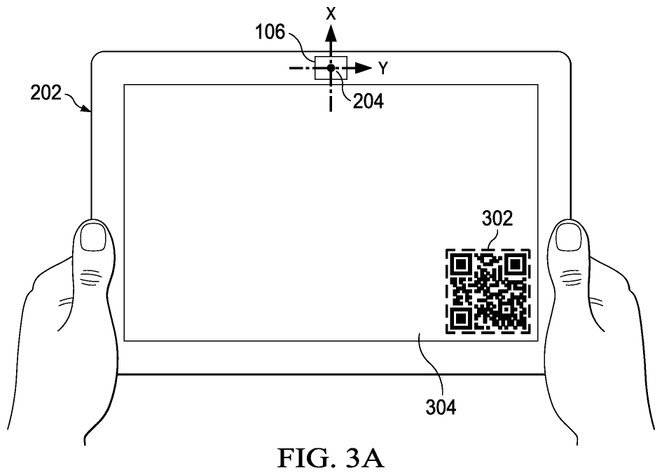

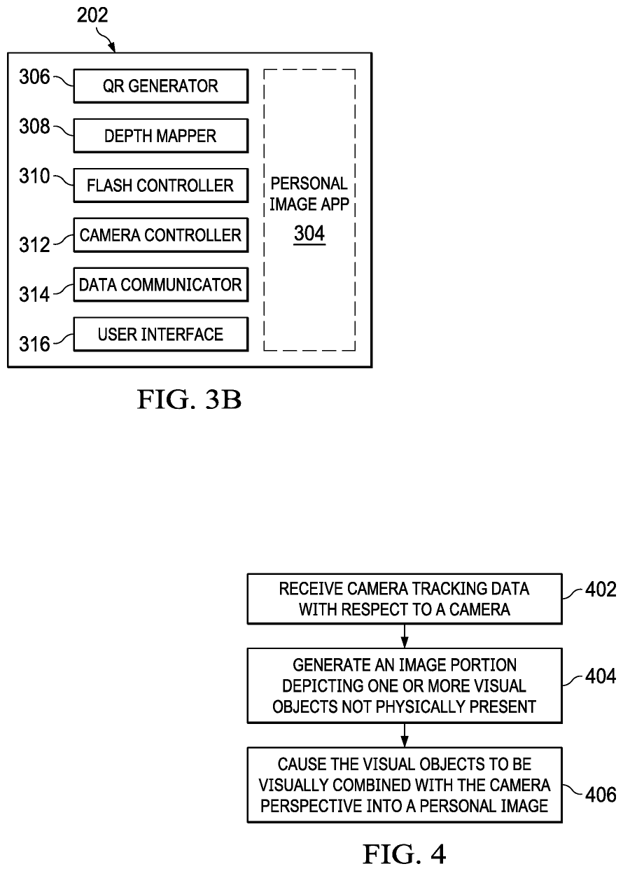

In some operational scenarios, a tracking image generated by the camera tracker (112) may contain a visual image portions depicting a two-dimensional QR code 302 on an image display 304 of the user device (202) hold by a user (e.g., 104 of FIG. 1A, etc.), as illustrated in FIG. 3A. This QR code (302) can be detected and (e.g., directly, simply, etc.) converted by the system (200) into a number of identifiers, data fields or parameter values that carry some or all of the device information about the specific type of the user device (202) or related camera tracking data.

The QR code—or information carried or (e.g., dynamically, statically, part statically part dynamically, etc.) encoded therein—can indicate, or be used to derive, a specific type of the user device (202), specific spatial dimensions of the user device (202), a specific camera being used as the camera (106) taking personal images or video, a specific position and device side at which the camera (106) is located, specific camera settings used by the camera (106) to take the personal images and video such as digital or optical camera magnification, zoom factors and other camera specific (or camera intrinsic) geometric or optical information, and so on.

Additionally, optionally or alternatively, the information carried by the QR code can be used to select a plurality of device stationary positions (e.g., four corner points, etc.) on the user device (202) to serve as fiducial markers. These fiducial markers can be tracked using tracking images generated by the camera tracker (112) and used to determine the real time spatial position and/or orientation of the user device (202) or the camera (106) in relation to the 3D physical space or the screen image display (102) at any given time point within a relatively strict time budget (e.g., one (1) millisecond or less, five (5) milliseconds or less, etc.). Example determination of positions and/or orientations using fiducial markers can be found in U.S. Pat. No. 10,726,574, by Ajit Ninan and Neil Mammen, the entire contents of which are hereby incorporated by reference as if fully set forth herein.

The real time spatial position and/or orientation of the user device (202) or the camera (106) in combination of concurrent or contemporaneous camera settings such as magnification or zoom factor can be used by the system (200) as a projection point to determine a specific shape, sizes or dimensions, etc., of the screen portion (110) in the screen image display (102) to concurrently present or render screen image portion(s) relative to the real time spatial position and/or orientation of the user device (202) or the camera (106). When the user device (202) or the camera (106) is moving to form a spatial trajectory, the perspective or projection point from the camera (106) correspondingly moves along the same spatial trajectory. The perspective or projection point from the camera (106) correspondingly moving along the same spatial trajectory in combination of concurrent or contemporaneous camera settings such as magnification or zoom factor can be used to (e.g., concurrently, in real time, in near real time, etc.) determine corresponding new spatial shapes, sizes, dimensions, etc., of the screen portion (110) in the screen image display (102) to concurrently present or render screen image portion(s) relative to the real time spatial position and/or orientation of the user device (202) or the camera (106). As a result, when the camera (106) is taking the personal images or video, visual objects depicted in in the screen image portion(s) such as the character or robot (108) of FIG. 1A can interact with the person (104) visually or virtually in the person images or video as if the person (104) and the character or robot (108) are in the same physical space as the person (104).

As previously noted, in some operational scenarios, the system (200) that controls image rendering operations of the (e.g., LED based, non-BED based, etc.) screen image display (102) can track cameras independently by itself without communicating with user devices that include these cameras.

In a first example, the system (200) can assume default camera settings such as current camera magnification or camera operational mode for a detected or tracked camera via tracking images generated or captured with the camera tracker (112). These default camera settings may be relatively inaccurate for at least some operational scenarios but may nevertheless be used to generate acceptable but somewhat inaccurate visual depiction of characters or objects on the screen image display (102). The visual depiction and rendering of the characters or objects can be adjusted based on real time camera perspectives determined (e.g., based at least in part on the real time tracking images, etc.) and/or assumed (e.g., based at least in part on the default camera settings, etc.) for the detected camera to achieve a relatively modest level of interaction and/or photorealism.

In a second example, the system (200) can initially assume default camera settings such as current camera magnification or camera operational mode for a detected or tracked camera via tracking images generated or captured with the camera tracker (112). The system (200) can use the tracking images without QR codes to try to identify a specific type (e.g., maker, model, etc.) for the user device (202). In response to determining or identifying the specific type such as a specific Samsung phone model, the system (200) can access and use camera data for the specific type for at least a part of overall camera tracking data to improve accuracy in its image rendering on the screen image display (102) and to increase the level of interaction and photorealism to a moderately high level as compared with that in the first example.

In a third example, the system (200) can initially assume default camera settings such as current camera magnification or camera operational mode for a detected or tracked camera via tracking images generated or captured with the camera tracker (112). The system (200) can use the tracking images with QR codes inside—as rendered by the user device (202)—to receive camera tracking data from encoded camera settings, data fields or parameter values in the QR codes. The camera tracking data can be dynamically coded into the QR codes by the user device (202). In response to receiving the camera tracking data including but not limited to the specific type such as a specific Samsung phone model, the system (200) can use the camera tracking data to improve accuracy in its image rendering on the screen image display (102) and to achieve a relatively high level of interaction and photorealism.

In a fourth example, the user device (202) may be downloaded and/or installed with a mobile application (or mobile app in short) that can establish a data communication link such as Bluetooth or Wi-Fi communication link with the system (200). Via the data communication link, the system (200) can receive camera tracking data from the user device (202). The camera tracking data can be dynamically coded into communication messages (or data units) from the user device (202) to the system (200). In response to receiving the camera tracking data including but not limited to the specific type such as a specific Samsung phone model, the system (200) can use the camera tracking data to improve accuracy in its image rendering on the screen image display (102) and to achieve a relatively high level of interaction and photorealism.

In a fifth example, the system (200) can initially assume default camera settings such as current camera magnification or camera operational mode for a detected or tracked camera via tracking images generated or captured with the camera tracker (112). The user device (202) may be downloaded and/or installed with a mobile application (or mobile app in short) that can encode camera tracking data dynamically into optical, LED, infrared or RF flash. Via the encoded flash detected by the system (200), the system (200) can receive the camera tracking data from the user device (202). In response to receiving the camera tracking data including but not limited to the specific type such as a specific Samsung phone model, the system (200) can use the camera tracking data to improve accuracy in its image rendering on the screen image display (102) and to achieve a relatively high level of interaction and photorealism.

Any of the non-QR-code-based camera tracking methods as discussed herein can be used to determine or estimate camera tracking data in operational scenarios (e.g., non-selfie-mode, etc.) in which the device image display (304 of FIG. 3A) is not available or visible in the tracking images.

Additionally, some or all of the camera tracking methods can be implemented or used by the system (200) to gather, convey, estimate, transmit and/or receive non-camera-tracking data such as user identification data, user preference data, user histories, (e.g., GPS, non-GPS, etc.) location data, etc., so long as user data protection laws or regulations are observed or followed.

In some operational scenarios, the screen image display (102) may be a relatively large image display, for example installed in a large or long entry way of a movie theater or another venue. As illustrated in FIG. 1B, while a user or person (e.g., 104, etc.) is taking personal images or video using a camera (e.g., 106, etc.) with a screen portion (e.g., 110, etc.) of the screen image display (102), other people can be taking their respective personal images or videos using different cameras (e.g., 106-1, etc.) with different screen portions (e.g., 110-1, etc.) of the screen image display (102). So long as all these screen portions (e.g., 110, 110-1, etc.) are spatially mutually exclusive, all the users or people can generate their photorealistic personal images or videos with their favorite characters or other visual objects specifically selected for these users. All perspective correct image portions can be respectively rendered in the screen portions (e.g., 110, 110-1, etc.) of the screen image display (102), for example by an overall image/video projector or as an overall LED wall display.

Visual objects (e.g., 108, 108-1, etc.) can be positioned and scaled, interact with different persons (e.g., 104, 104-1, etc.), show/disocclude image details previously occluded, and hide/occlude image details previously disoccluded, in response to changes in the camera perspective over time. Additionally, optionally or alternatively, these visual objects are captured in the personal images with the same or similar lighting conditions/characteristics or visual effects prevailing in the same 3D physical space in which the persons (e.g., 104, 104-1, etc.) and the screen image display (102) are present. Any lighting effects or changes in the 3D physical space including but not limited to those caused by physical movements of the person (104) or the camera (106) are reflected simultaneously in both the person (104) (if the camera (106) is taking selfie images)—or physical objects/characters (if the camera (106) is taking non-selfie personal images) present in the 3D physical space—and the image portion on the screen image display (102) as captured by the camera (106). As a result, like the person (104) or other visual objects/characters physically present in the 3D physical space, these visual characters not physically present in the 3D physical space, as added or combined into the personal images, look proportional, realistically positioned, volumetric, interactive, photorealistic and animated.

In some operational scenarios in which multiple persons are taking respective personal images or videos in the same 3D physical space, multiple camera trackers (e.g., 112, 112-1, etc.) may be deployed with the screen image display (102) to track the different persons, different user devices operated by the different persons, different cameras (on respective user devices) being used to take the respective personal images or videos. Additionally, optionally or alternatively, multiple screen image displays (e.g., 102, etc.) may be used to provide different screen portions to rendering different image portions for different persons.

In some operational scenarios, different visual characters are selected for different persons taking their respective personal images or videos. For example, the Luke Skywalker character may be selected to be presented or rendered in the screen image display (102) for a first person, whereas a character acted by Brad Pitt may be selected to be presented or rendered in the screen image display (102) for a second person. In a first example, a mobile app that has been downloaded or installed on a user device as described herein may be communicated with the system (200) to convey user preferences or user selection for particular character(s), particular scene(s), particular visual object(s), particular music piece(s), etc., to be presented or rendered with the screen image display (102). In a second example, a person may hold an invitation card or an event ticket sub that can be detected in tracking images. The information (e.g., encoded with a QR code, written without QR code, etc.) on the invitation card or the event ticket sub, including possibly user identification information, can be decoded or parsed, and used to select articular character(s), particular scene(s), particular visual object(s), particular music piece(s), etc., to be presented or rendered with the screen image display (102).

In some operational scenarios, the user device (202), or a mobile app running thereon, can use camera sensors on the user device (202) to generate a depth map of the spatial shape of the person (104) who is taking personal or selfie images or video and/or other visual objects/characters physically present in the 3D physical space. The depth map may comprise precise 3D locational information such as depths, distances and parallax information of pixels depicting image details (e.g., shoulder, hand, foot, elbow, knee, head, face, fingers, hair, etc., of the person (106), etc.) and/or the other visual objects/characters relative to (or in reference to) the real time spatial position and orientation of the camera (106) or the real time perspective of the camera (106).

This depth map can be communicated to the system (200) via a (e.g., Bluetooth, Wi-Fi, etc.) data communication link between the user device (202) and the system (200). The depth map of the person (104) can be used by the system (200) to project and render visual characters or objects in the screen portion (110) of the screen image display (102) such that the personal or selfie images or video depicts relatively close, relatively intimate (e.g., tactile, etc.) interaction between the rendered visual characters or objects and the person (104).

For example, without such a depth map available to the system (200), the system (200) may be implemented to logically place or project the visual characters or objects at spatial locations that are safe distances away from the person (104).

In contrast, with the depth map acquired by and sent from the user device (202) to the system (200), the system (200) may be implemented to logically place or project the visual characters or objects at close (e.g., tactile, etc.) contact with the person (104). As a non-limiting illustrative example, a hand of a famous character not physically present in the 3D physical space may be projected or rendered under techniques as described herein to be precisely placed on the shoulder of the person (104)—using accurate 3D positional information of the shoulder of the person (104) as conveyed through the depth map—while the person (104) is taking the personal or selfie images or video.

### 4. CHARACTER OR VISUAL OBJECT INSERTION

In some operational scenarios, visual characters or objects can be inserted into personal images without using a stationary image display (e.g., 102 of FIG. 1A, FIG. 1B or FIG. 2A, etc.).

FIG. 2B illustrates an example visual object insertion system 250 in which the position and/or orientation of a user device 202 may be tracked or monitored in real time while visual characters or objects are being inserted or superimposed visually into personal images or video being taken with a camera (e.g., 106, etc.) of a user device (202) operated by a person (e.g., 104, etc.). Some or all of the components and/or devices as depicted in FIG. 2B may be implemented by one or more mechanical components, one or more electrooptical components, one or more computing devices, modules, units, etc., in software, hardware, a combination of software and hardware, etc.

As shown, the visual object insertion system (250) comprises a personal image receiver 214, a visual object inserter 216, etc., in addition to other devices/modules/components similar to those of the screen image adjustment system (200) such as a tracking data receiver (e.g., 206, etc.), a tracking data analyzer (e.g., 208, etc.), an image portion generator 210, etc.

In some operational scenarios, the user device (202), or a mobile application running therein, establishes a (e.g., Bluetooth, Wi-Fi, carrier supported, telco enabled, etc.) data communication link with the visual object insertion system (250). In an example, a QR code 218 on a wall 220 in a 3D physical space may be used by the user device (202) to establish the data communication link with the visual object insertion system (250). In another example, a QR code on a ticket stub or some item available to the user (104) or the user device (202) may be accessed or used by the user device (202) to establish the data communication link with the visual object insertion system (250).

The visual object insertion system (250), or the personal image receiver (214) therein, can receive the personal images or video (without the inserted visual characters or objects) from the user device (202) via the data communication.

The visual object insertion system (250), or the visual object inserter (216) therein, can insert or superimpose visually the visual characters or objects into the personal images or video (without the inserted visual characters or objects) to generate superimposed personal images or video with the inserted visual characters or objects. The superimpose personal images or video may be sent by the visual object insertion system (250) to a destination such as the user device (202) (e.g., via the data communication, etc.), a cloud-based content service system, a social networking portal such as Twitter, Instagram, Facebook, YouTube, TikTok, etc.

Superimposed personal images or videos are of correct perspectives as monitored and tracked with the camera tracker (112), similar to how visual characters or objects are projected or rendered in the screen image display (102) by the system (200) of FIG. 2A using the camera perspectives monitored or tracked with the camera tracker (112).

The inserted visual characters or objects without using a screen image display can be similarly animated with time-varying interactions (e.g., synchronized, etc.) with positions, orientations, and movements, of the person (104), as in the case of projecting or rendering visual characters or objects with using a screen image display.

In the case of a screen image display being used to add visual characters or objects into personal images or videos, photorealism in the resultant personal images or videos is enhanced in part because the same lighting conditions/characteristics/effects in the 3D physical space affects both the screen image display and the person (or the personal images or video being taken by the camera of the user device). As a result, the visual characters/objects projected or rendering on the screen image display and the (physical) person or objects in the 3D physical space can be captured by the camera with the same time-synchronous lighting conditions or lighting characteristics or lighting effects.

In the case of a visual character/object insertion or superimposition without screen image display, 3D rendering models or (e.g., single view, multi view, texture, depth, etc.) images used to perform visual character/object insertion based on a contemporaneous camera perspective dynamically monitored may still have different lighting conditions/effects. In some operational scenarios, logical or virtual re-lighting operations (e.g., ray tracing, virtual light casting, virtual light source placements used to virtually illuminate the visual characters or objects, etc.) may be performed to match virtual lighting conditions/effects of the inserted or superimposed visual characters or objects with the lighting conditions/effects prevailing in the 3D physical space. As a result, photorealism can be enhanced even without using screen image display. For example, time varying skin reflection of the person may look similar (e.g., same green light in the 3D physical space, lighting changing or varying in time synchronously, etc.) to that of the inserted visual characters/objects.

As in the case of a screen image display being used to add visual characters or objects into personal images or videos, inserting or superimposing visual characters or objects without screen image display can receive and use contemporaneous depth maps (e.g., of the person, etc.) acquired by the user device (202) to place the visual characters or objects relatively accurately in relation to (the visual depiction of) the person. For example, tactile contact such as placing hands on shoulders or other bodily contact may be simulated in the superimposed personal images or videos to achieve a relatively high level of interaction.

### 5. EXAMPLE USER DEVICE

FIG. 3B illustrates an example user device 202 that include one or more cameras (e.g., 106, etc.) used to take personal images or videos. The user device (202) may comprise some or all of: a QR (quick response code) generator 306, a depth mapper 308, a flash controller 310, a camera controller 312, a data communicator 314, a user interface 316, etc. Any, some or all components of the user device (202) may be implemented via hardware, software, firmware, any combination of the foregoing, etc. More or fewer components may be used or implemented in various operational scenarios with one or more of: a specifically designed processor, a general purpose single- or multi-chip processor, a digital signal processor (DSP), an application specific integrated circuit (ASIC), a field programmable gate array (FPGA) or other programmable logic device, discrete gate or transistor logic, discrete hardware components, transitory or non-transitory media, random access memory (RAM) devices, read-only memory (ROM) devices, etc.

One or more computer applications such as mobile applications, originally installed applications, etc., may be running on the user device (202). The computer applications may include a personal image application (or app) 304 that operate with one or more other devices/components/units/blocks of the user device (202) to produce personal images or videos as described herein.

The data communicator (314) may include or operate with one or more network and/or data interfaces to support wired and/or wireless network and/or data communications (e.g., Bluetooth, Wi-Fi, radio frequency or RF, infrared, optical, LED, GPS, etc.) with other modules/devices/systems as described herein.

The user interface (316) may be implemented or used to interact with a user (e.g., the person (104), etc.) operating the user device (202). For example, in some operational scenarios. The user interface (316) can render graphic controls on a graphic user interface of the user device (202) to present to the person (104) with a plurality of candidate visual characters, objects, scenes, etc. The person (104) can interact or use the graphic controls to select one or more of: specific visual characters, objects, scenes, etc., to be projected with monitored camera perspectives on a screen image screen (e.g., 102 of FIG. 1A, FIG. 1B or FIG. 2A, etc.) or to be inserted or imposed with monitored camera perspectives without using a screen image screen.

The camera controller (312) may be implemented or used to apply applicable (e.g., default, user-selected, etc.) camera settings to a specific camera (e.g., 106 of FIG. 1A, FIG. 1B, FIG. 2A or FIG. 2B, etc.) used to take personal images or video at any given time.

The QR generator (306) may be implemented or used to (e.g., dynamically, statically, part dynamically part statically, etc.) encode a number of identifiers, data fields or parameter values that carry some or all of device information about the specific type of the user device (202) or related camera tracking data including the applicable camera settings into one or more QR codes. Each of these QR codes can be rendered by the user device (202) on an image display included in or operating with the user device (202).

The flash controller (310) may be implemented or used to (e.g., dynamically, statically, part dynamically part statically, etc.) encode a number of identifiers, data fields or parameter values that carry some or all of device information about the specific type of the user device (202) or related camera tracking data including the applicable camera settings into optical or LED codes into optical or LED flash emitted by the user device (202).

The depth mapper (308) may be implemented or used to capture or generate depth maps of the person (104) or other (physical) objects/persons that may be physically present in the 3D physical space. These depth maps can be communicated to a recipient device or system such as the system (200 of FIG. 2A or 250 of FIG. 2B).

### 6. EXAMPLE PROCESS FLOWS

FIG. 4 illustrates an example process flow. In some example embodiments, one or more computing devices or components may perform this process flow. In block 402, a system (e.g., an image rendering system, an image processing system with a screen image display, an image processing system without a screen image display, etc.) receives camera tracking data with respect to a camera operating in a three-dimensional (3D) physical space.

In block 404, the system generates an image portion depicting one or more visual objects not physically present in the 3D physical space using a camera perspective derived from the camera tracking data.

In block 406, the system causes the one or more visual objects to be visually combined with the camera perspective into a personal image taken by the camera.

In an embodiment, the camera represents one of one or more cameras included in a user device.

In an embodiment, the personal image visually depicts one or more visual objects physically present in the 3D physical space.

In an embodiment, the one or more visual objects are combined into the personal image taken by the camera by way of contemporaneously rendering the image portion on a screen image display in the 3D physical space.

In an embodiment, the one or more visual objects are combined into the personal image by way of superimposing the image portion onto a pre-combined personal image taken by the camera.

In an embodiment, lighting conditions existing in the 3D physical space are simulated in the image portion superimposed onto the pre-combined personal image.

In an embodiment, a depth map is received and used to cause at least one of the one or more visual objects to visually appear, in the personal image, to have physical contact with a visual object physically present in the 3D physical space.

In an embodiment, the camera perspective is represented by a spatial position and a spatial orientation, of the camera; the spatial position and the spatial orientation, of the camera, are determined in reference to the 3D physical space.

In an embodiment, at least a part of the camera tracking data is received by tracking and decoding a visual representation of a quick response (QR) code presented on a device image display.

In an embodiment, the system further performs: receiving second camera tracking data with respect to a second camera operating in the 3D physical space; generating a second image portion depicting one or more second visual objects not physically present in the 3D physical space using a second camera perspective derived from the second camera tracking data; causing the one or more second visual objects to be visually combined with the second camera perspective into a second personal image taken by the second camera.

In an embodiment, at least a part of the camera tracking data is predicted by a machine learning model that has been trained with training data that includes training tracking images of user devices that include cameras.

In an embodiment, a visual representation of a specific quick response (QR) code is accessible to a user device that includes the camera to establish a data communication link with a system that generates the image portion.

In an embodiment, the image portion is generated using one of: 3D rendering models, single view images, multi view images, stereoscopic images, etc.

In an embodiment, a display system comprises: a non-stationary image display that renders non-screen display images; a stationary image display that renders screen display images; an image rendering controller that performs at least a part of the foregoing methods or operations.

In various example embodiments, an apparatus, a system, an apparatus, or one or more other computing devices performs any or a part of the foregoing methods as described. In an embodiment, a non-transitory computer readable storage medium stores software instructions, which when executed by one or more processors cause performance of a method as described herein.

Note that, although separate embodiments are discussed herein, any combination of embodiments and/or partial embodiments discussed herein may be combined to form further embodiments.

### 7. IMPLEMENTATION MECHANISMS—HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

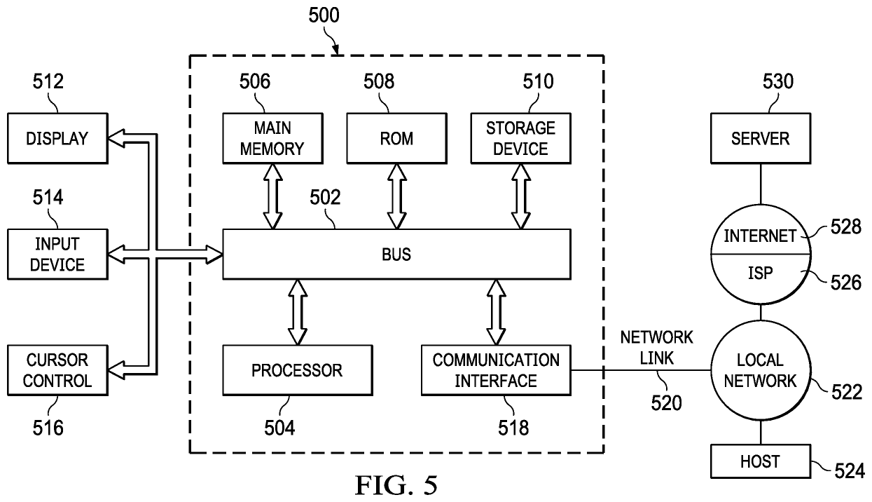

For example, FIG. 5 is a block diagram that illustrates a computer system 500 upon which an example embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504.

A storage device 510, such as a magnetic disk or optical disk, solid state RAM, is provided and coupled to bus 502 for storing information and instructions.

Computer system 500 may be coupled via bus 502 to a display 512, such as a liquid crystal display, for displaying information to a computer viewer. An input device 514, including alphanumeric and other keys, is coupled to bus 502 for communicating information and command selections to processor 504. Another type of viewer input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. EQUIVALENTS, EXTENSIONS, ALTERNATIVES AND MISCELLANEOUS

In the foregoing specification, example embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method, comprising:
receiving camera tracking data with respect to a camera being operated by a first user physically present in a three-dimensional (3D) physical space;
generating an image portion depicting one or more visual objects not physically present in the 3D physical space using a camera perspective derived from the camera tracking data;
causing the one or more visual objects to be visually combined with the camera perspective into a personal image taken by the first user using the camera, wherein the personal image visually depicts one or more visual objects physically present in the 3D physical space.

2. The method of claim 1, wherein the camera represents one of one or more cameras included in a user device.

3. The method of claim 1, wherein the one or more visual objects are combined into the personal image taken by the camera by way of contemporaneously rendering the image portion on a screen image display in the 3D physical space.

4. The method of claim 1, wherein the one or more visual objects are combined into the personal image by way of superimposing the image portion onto a pre-combined personal image taken by the camera.

5. The method of claim 4, wherein lighting conditions existing in the 3D physical space are simulated in the image portion superimposed onto the pre-combined personal image.

6. The method of claim 1, wherein a depth map is received and used to cause at least one of the one or more visual objects to visually appear, in the personal image, to have physical contact with a visual object physically present in the 3D physical space.

7. The method of claim 1, wherein the camera perspective is represented by a spatial position and a spatial orientation, of the camera; wherein the spatial position and the spatial orientation, of the camera, are determined in reference to the 3D physical space.

8. The method of claim 1, wherein at least a part of the camera tracking data is received by tracking and decoding a visual representation of a quick response (QR) code presented on a device image display.

9. The method of claim 1, further comprising:
receiving second camera tracking data with respect to a second camera being operated by a second user physically present in the 3D physical space;
generating a second image portion depicting one or more second visual objects not physically present in the 3D physical space using a second camera perspective derived from the second camera tracking data;
causing the one or more second visual objects to be visually combined with the second camera perspective into a second personal image taken by the second user using the second camera.

10. The method of claim 1, wherein at least a part of the camera tracking data is predicted by a machine learning model that has been trained with training data that includes training tracking images of user devices that include cameras.

11. The method of claim 1, wherein a visual representation of a specific quick response (QR) code is accessible to a user device that includes the camera to establish a data communication link with a system that generates the image portion.

12. The method of claim 1, wherein the image portion is generated using one of: 3D rendering models, single view images, multi view images, or stereoscopic images.

13. A non-tangible computer readable storage medium, storing software instructions, which when executed by one or more computer processors cause performance of at least a part of the method recited in claim 1.

14. An apparatus comprising one or more computer processors and one or more storage media storing a set of instructions which, when executed by the one or more computer processors, cause performance of at least a part of the method recited in claim 1.
